(19) United States
(12) Patent Application Publication
(10) Pub. No.: US 2006/0029791 A1
(43) Pub. Date: Feb. 9, 2006

(54) Product Comprising a Thin-film Radiation-cured Coating on a Three-dimensional Substrate

(75) Inventors: Melanie S. Cambell, Freeport, PA (US); Richard Foukes, Mars, PA (US); Karen A. Barkac, North Huntingdon, PA (US); David Hagopian, Deerfield, IL (US); Alan Smock, Dubois, IN (US); Inho Song, Chesterland, OH (US)

Correspondence Address: CALFEE HALTER & GRISWOLD, LLP, 800 SUPERIOR AVENUE, SUITE 1400, CLEVELAND, OH, 44114, US

(73) Assignee: MASTERBRAND CABINETS, INC., Jasper, IN (US)

(21) Appl. No.: 10/710,810

(22) Filed: Aug. 4, 2004

(51) Int. Cl. B32B 5/16; G11B 5/64

(52) U.S. Cl. 428/323; 428/336

(57) ABSTRACT

A process for providing a uniform coating of one hundred percent solids material on a substrate and a substrate having a uniform coating of one hundred percent solids material. Process parameters are controlled to provide for a sprayable, curable coating of one hundred percent solids material that can be used to coat three dimensional surfaces and provide a uniform thin film layer across all areas of the three dimensional surface.

### BACKGROUND OF INVENTION

In order to provide a finished look to substrates, such as woodworking and cabinets, coatings are applied to the substrate. Typically, the finish on wood products are made up of four components, a toner, a stain, a sealer and a topcoat. The toner is applied to the substrate to ensure an even rate of absorption of stain on the wood, thereby preventing undesirable color contrasts. The stain is applied to achieve the desired color of the end product. The sealer coat is then applied, followed up by a topcoat. The sealer and topcoat are both clear coats and typically include organic-based solvents and/or water as a diluent. In some instances the topcoat and sealer are reduced organic solvent content materials or water based, which also contain some organic solvent content. The sealer and topcoats provide a glossy finish and provide protection against the application, or absorption, of additional materials by filling the pores of the wood. FIG. 1 is a picture of an example wood substrate, a cabinet door.

In many stains, organic solvent helps carry the stain into the pores of the substrate. This produces a richness and depth in the appearance of the substrate that cannot readily be achieved by other methods. The topcoat and sealer must also be delivered to the pores of the wood and organic solvent is an ideal carrier of the sealer materials. Other carriers include reduced organic solvents and water-based materials. These carriers have inherent problems in application. For example reduced organic solvents may result in an undesirable “thicker” or “plastic” appearance, while water-based materials will cause the grain of wood to rise, thereby distorting the substrate. As such, the use of water-based material requires additional sanding of the substrate, which is typically cost prohibitive or results in an undesirable appearance.

Traditionally, the finishing coatings are sprayed onto the substrate. Wet applications result in a “wet” coating thickness of three to four mils that is reduced to one mil after the material is dried or cured, usually in a thermal operation. The process takes approximately one to three hours from toner application to the curing of topcoat. Thereafter, the substrates cannot be stacked or otherwise come in contact with each other or anything else for an additional four to eight hours to prevent “sticking.” Additionally, these traditional methods of wood coating are significantly effected by ambient conditions, particularly temperature and humidity. Moisture causes an undesirable “rising” of the wood grain due to the process of hydration. Hydration is a process by which the cells of the substrate absorb water. Hydration of the wood grain cells results in a non-uniform volume expansion of the substrate. Specifically with a sanded wood substrate, the wood grain will rise and a “feathering” of the surface will result in an uneven, rough appearance. Although any low viscosity liquid that is allowed to “dive into” the pores of the wood can result in an expansion of the substrate, in the absence of hydration, this expansion is quite often negligible. Furthermore, many traditional coating technologies, whether organic solvent or water-based, utilize electrostatic coating systems. Salt water mist is added to these components to allow for electrical conductivity. The amount of mist applied is based in part on the system design and the ambient humidity. Thus system performance can vary based on the surrounding environmental conditions.

Currently topcoat and sealer coating compositions exist in the market that have little or no organic solvent or water content. These coating formulations are radiation curable and are typically used in the pre-finished wood flooring industry and, to a lesser degree, for frame components in the wood cabinetry industry. These coatings are also commonly known as “100 percent solids coatings.” While “100 percent solids coatings” generally refers to coatings that are solvent-free or substantially solvent-free, as used herein “100 percent solids coatings” includes solvent-free compositions, substantially solvent-free compositions, and predominately solids compositions, such as those with twenty percent or less solvent. Such coating compositions that are radiation curable, essentially solvent-free and/or sprayable are often desired, particularly for wood finish applications. Radiation curable coatings, such as those cured by exposure to ultraviolet (“UV”) radiation, are often preferred for wood finish applications because of the heat sensitivity of wood, which often makes thermosetting coatings unfavorable. Acrylated resins are radiation curable and are often used in wood finish coatings. These 100 percent solids coatings may contain minor amounts of organic solvents, which are byproducts of manufacturing, but are otherwise solvent-free. Due to the relative cost of the coating versus the solvent, 100 percent solids coatings have a much higher cost on a per gallon basis than traditional organic solvent or water-based coatings, typically four to ten times the cost. Since there is little to no solvent, the 100 percent solids material is typically more viscous than the traditional coatings and is not easily atomized on a substrate.

Sprayable coatings are often desired as well. Such coatings may be particularly desirable when the article to be coated is irregularly shaped, since those objects can be difficult to effectively coat by other methods, such as roll-coating. A sprayable coating is a coating that is capable of being applied uniformly by atomization through a device such as a spray gun. Sprayability is a function of the rheology profile, i.e., viscosity, of the coating. Typically, a coating with a viscosity of about 2 to about 300 centipoises at 25 degrees Celsius is considered to be sprayable. Historically, solvents, such as water or organic solvents, have been required to attain such viscosities in radiation curable wood coatings. More recently, however, reactive diluents, such as relatively low molecular weight acrylate monomers, especially monofunctional acrylate monomers, have been used to achieve sprayability. These diluents react into and become part of the coating.

Several coating compositions that purportedly contain one or more of these attributes have been proposed. For example, U.S. Pat. No. 4,319,811 (“the '811 patent”) describes a coating composition that is alleged to be radiation curable, sprayable, and solvent-free. The composition described in the '811 patent is substantially oligomer-free and is obtained by copolymerizing a first monomer that is either a triacrylate or a tetraacrylate with a second monomer having an N-vinyl imido group. The composition may also include a photoinitiator, wetting agents, a surfactant, and other additives.

U.S. Pat. No. 5,453,451 (“the “451 patent”) discloses a coating composition that is also purported to be radiation curable, sprayable, and essentially solvent-free. The compositions described in the “451 patent comprise a polymerizable compound and a photoinitiator. The polymerizable compound is present in an amount ranging from about 80 to about 99.5 percent by weight, based on the total weight of the composition, and comprises a mixture of acrylates, which may include monoacrylates, diacrylates, triacrylates, urethane-modified acrylates, polyester-modified acrylates or a mixture thereof. The photoinitiator is present in an amount ranging from about 0.5 to 15 percent by weight, based on the total weight of the composition, and comprises a free radical or cationic type photoinitiator.

U.S. Pat. No. 6,231,931 (“the “931 patent”) discloses a method of coating a substrate using a substantially 100 percent solids, acrylate-containing UV curable coating composition. The acrylate polymer may be a monoacrylate, diacrylate, triacrylate, urethane-modified acrylate, polyester-modified acrylate, or a mixture thereof. According to the “931 patent, when the composition is to be spray applied to a substrate, the composition should include a mixture of at least one high molecular weight polymer and at least one low molecular weight polymer. The “931 patent also states that, to avoid phase separation during spray application at ambient temperature and pressure, a mixture of 40 percent high molecular weight polymers and 60 percent low molecular weight polymers should be used.

The 100 percent solids coatings, like the solvent-based coatings, can be applied at a two to four mils build thickness prior to cure utilizing various spray application technologies that are currently available. However, if 100 percent solids coatings are applied utilizing spray application technologies that are currently available and then cured with uv radiation, the cured film thickness would also be two to four mils. This results in an undesirable appearance of the finished product, as it would appear “thick” and “plastic-coated.” As such, use of conventional spraying techniques, such as conventional airless, air-assisted-airless and high volume low pressure (HVLP) technologies, to apply 100 percent solids coatings does not provide for adequate results. The coatings in the two to four mil wet coating range resulted in a “thick” appearance on large, two-dimensional surfaces and thin, non-uniform coatings on surfaces that were not perpendicular to the point of dispensation. Such areas on wood cabinet doors are the recessed areas along the side and top rails.

“Thin films” (0.2 mils to 2 mils) are not typically desired when using organic solvent or water-based coatings due to poor appearance after cure. The finished product appears dry, blotchy, or uncoated. Thin films of 100 percent solids coatings do present a desirable appearance simply because the cured film thickness is equal to the uncured or wet film thickness. Thin film coatings of 100 percent solids coatings are readily achievable utilizing several application technologies, such as vacuum coating, curtain coating, and roll-on applicators. These technologies, however, are only viable on two-dimensional substrates since the coatings are difficult to apply to edges, corners and cracks in the substrate. Examples of substrates coated with these techniques include linear wood cabinet components and wood flooring. In order to use these technologies on three dimensional substrates, the coatings are applied in larger quantities than needed, thereby producing waste of the coatings and an uneven application of the coating on the substrate. Also, some application technologies are simply not suitable for 3-dimensional substrates. Thin film spray application of 100 percent solids coatings has typically resulted in blotchy, dry, and uneven coatings. Furthermore, the coating failed to evenly enter areas of the substrates where there were not a perpendicular surface to the point of dispensation. Inadequate coverage is produced in recessed areas, while in large flat, open areas the 100 percent solids material does not “knit” to form a cohesive coating.

### SUMMARY OF INVENTION

The present invention relates to a process of coating a substrate with a thin film on one hundred percents solids material. The present invention further relates to a product comprising a substrate and a one hundred percent solids coating applied to the substrate. In some embodiments, the coating is applied uniformly on the substrate to form a thin layer of coating that is less than 0.001 inches (1 mil) thick. In some embodiments the substrate is three-dimensional, including corners and edges.

### BRIEF DESCRIPTION OF DRAWINGS

In the accompanying drawings, which are incorporated in and constitute a part of this specification, embodiments of the invention are illustrated, which, together with a general description of the invention given above, and the detailed description given below serve to illustrate the principles of this invention.

FIG. 1 is a picture of a finished wood substrate.

FIG. 2 is a perspective view of an illustrative example of a spray coating applicator.

FIG. 3 is a cross-sectional view of the spray coating applicator shown in FIG. 2.

FIG. 4 is a schematic of a conventional coating gun.

FIG. 5 illustrates a SATA LP™ jet K3™ HVLP Automatic high performance spray gun.

FIG. 6 illustrates a Can-Am #2100 RC Fluid Recirculation Automatic Spray Gun.

FIG. 7 is a graphical representation of the adiabatic effects experienced using the Can-Am-type gun and the Sata-Type gun.

FIG. 8 is a graphical representation of air speed versus distance from the gun.

FIG. 9 is a graphical analysis of the particle size distribution generated by different HVLP guns.

FIG. 10 illustrates a spray pattern hitting the surface of a substrate.

FIG. 11 is a graphical analysis of the surface energy of different substrates compared to the surface tension of the coating material.

FIG. 12 illustrates a Dubois Mist Coater, an illustrative example of an applicator that can be used in connection with the present invention.

FIG. 13 illustrates the coating spray pattern from a coating gun.

### DETAILED DESCRIPTION

The present invention is directed to a substrate, such as, for example, a wooden cabinet or component thereof, with a thin film coating applied uniformly thereto. This invention is further directed to a system and method for applying 100 percent solids coatings. This system and method identifies the fundamental variables, processes, and equipment that are needed to establish a uniform thin 100 percent solids coating on a substrate. The process and system described and claimed in this application provides a product, such as a wooden cabinet component, with a uniform thin film 100 percent solids coating.

Use of the process of the present invention allows for the application of a uniform thin film of 100 percent solids coatings to be applied to a three-dimensional substrate, thereby avoiding the use of an organic solvent or water-based delivery system. The elimination of these carrier agents will drive down production throughput time and complement a “just-in-time” or “lean” manufacturing system. Furthermore, the elimination of organic solvent and water-based coatings, which contain some amount of organic solvents, will reduce waste product streams and the expenditure associated with the proper treatment or disposal of such streams. Additionally, the elimination of carrier agents, or solvents, in the coatings allows formulators to develop coatings with a specific focus on coating performance without regard to the need to remove the carrier. Thus, improved coating performance can be achieved. In the case of water-based coatings applied to wood substrates, the effect of hydration can be minimized through use of 100 percent solids coatings. Since the cost of the 100 percent solids material is much higher than the cost than the cost of solvent-based coatings, it is important to achieve a high transfer efficiency. Implementation of the process disclosed in this application will utilize high transfer efficiency.

The process of this application provides for improved “knitting” of 100 percent solids coatings to match that of conventional solvent-based coatings. “Knitting” of the coating refers to the flow of the material to form a uniform thin film. For example, wood and metal surfaces where “knitting” failures are evident appear to have small “specs” of material that stand up on the substrate and do not flow out. The process of this application further provides for improved coating build on recessed or non-planar surfaces. Furthermore, the process described herein maximizes transfer efficiency of the material. These significant improvements in the 100 percent solids coatings application provide for a uniform thin film build on three-dimensional surfaces. The details of the process are further described below.

This description is divided into subsections: the first subsection describes the fundamental components and process parameters of the system, the second subsection describes the overall process employed to provide a uniform coating of 100 percent solids material, and the third subsection describes the product resulting therefrom. It should be appreciated by one skilled in the art that a number of different components and parameters are defined herein to provide only preferred embodiments of a process and product, and that use of subcombinations of these components and parameters and other embodiments are contemplated by the present invention. In this regard, the present invention is not intended to be limited to the components and parameters discussed herein and in the processes described herein, but instead should be applied to the broad, general inventive concepts contained herein and which are described by the claims of this application.

Application of finishing coatings is typically performed in a coating applicator, such as the apparatus described in U.S. patent application Ser. No. 10/262,119 published under Publication No. 20030183166 on Oct. 2, 2003, now U.S. Pat. No. 6,746,535, the entire disclosure of which is hereby incorporated by reference. While the specific embodiments used to implement the claimed process and produce the claimed product can be varied, a description of some of these embodiments is provided in further detail below.

A. Components of System and Process Parameters

1. Overview

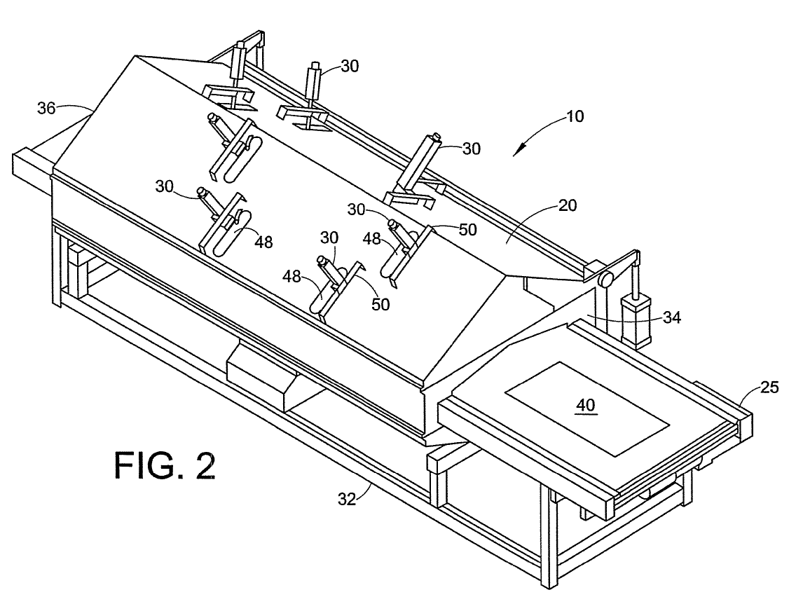

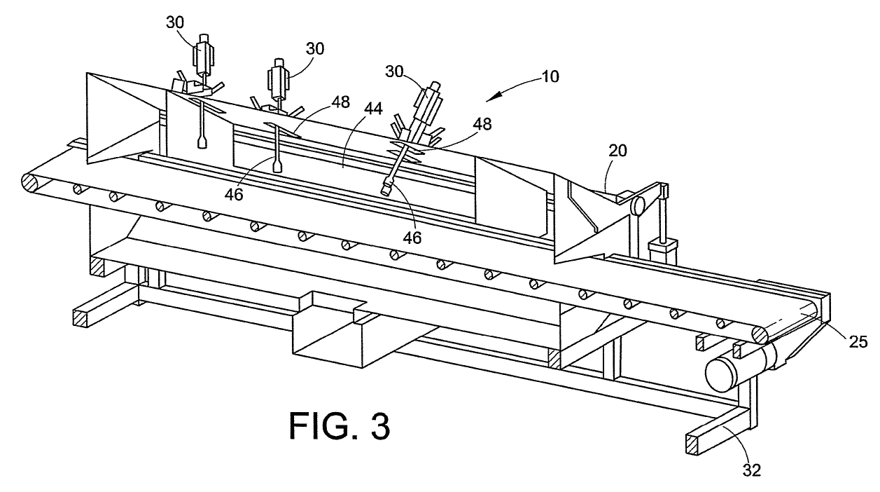

FIG. 2 is a perspective view illustrating the general components of a coating applicator, generally referenced as 10. The applicator 10 generally comprises a spray housing 20, a conveyor means 25 and a plurality of spray guns 30. Seven spray guns 30 are shown in FIG. 2, however any number of guns can be used to achieve the desired spray pattern. As shown in FIG. 2, the spray housing 20 is mounted on a frame assembly 32 and has an entry 34 and an exit 36, through which the conveyor means 25 passes. The component to be finished 40 is placed on the conveyor means 25. The conveyor means 25 delivers the component 40 into the spray chamber 44 located within the spray housing 20. The spray guns 30 are positioned on the spray housing 20 such that the nozzle portion 46 (see FIG. 3) of each of gun 30 passes through an opening 48 in the spray housing 20 and enters the spray chamber 44. The spray guns 30 can be positioned anywhere on the spray housing 20 and pointed in any desired direction to provide the desired spray pattern. For example, the guns 30 may be mounted on a slide post 50 that allows adjustment in at least one direction. Further, as shown in the FIGS. 2 and 3, the guns 30 may be angled toward the center of the spray chamber 44 to maximize coating recovery. Additional features of the coating applicator 10 are shown in FIGS. 2 and 3, however are not essential to the understanding of the present invention. Furthermore, the coating applicator 10 shown in FIGS. 2 and 3 is merely an illustrative example of the general components of a spray applicator and as such are not meant to be limiting in any way.

There are several parameters which can be used or controlled to provide the desired finished product. For example, the system can employ high precision guns to ensure proper delivery of the material to the substrate, the temperature of the input streams can be controlled to provide for the best transfer efficiency and material flow-out, and the material used can be selected to ensure proper rheology, size and velocity to effectuate a proper coating of the substrate. These and other parameters are discussed in further detail below.

2. Use of High Precision Guns

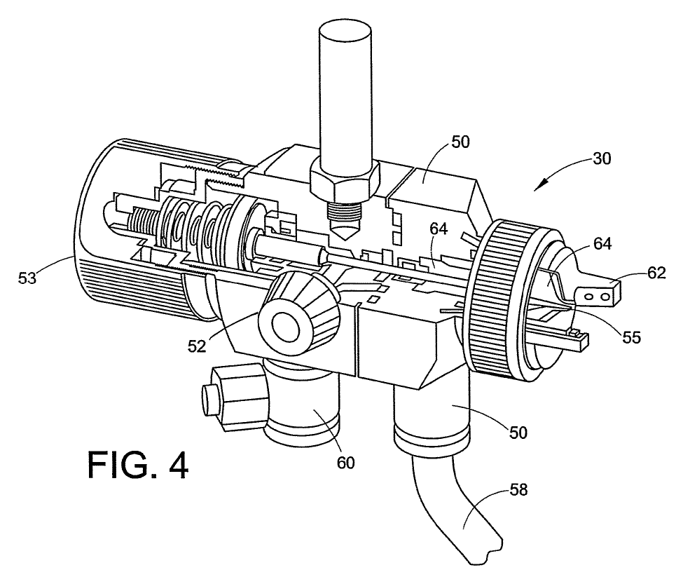

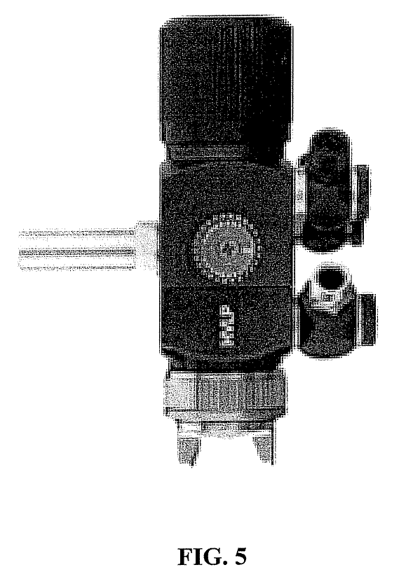

The guns 30 are used to apply the coating material, atomize the coating, distribute the coating, and deliver the coating to the substrate 40. Coating guns 30 generally consist of a body 50, valving 52, a material flow control apparatus 53 a coating nozzle 55 located on a gun head, coating input 58, air input 60 and side nozzle, or horn, 62. The gun shown in FIG. 4 is an illustrative example of a conventional high volume low pressure (HVLP) gun, such as the SATA LP™ jet K3™ HVLP. As shown in FIG. 4 coating material enters the gun chamber 64 through coating input 58, from a feed line (not shown). Air enters the gun chamber 64 through air input 60. The coating material is atomized in the gun spray chamber 64 and then carried to the coating nozzle 55 where it is dispensed from the gun. A portion of the air passes through the gun and out side nozzles 62. The air that flows out of the side nozzles 62 provides for the spray fan pattern, as described further below. The coating is then sprayed onto a substrate 40, as shown in FIG. 5, in a controlled fan pattern to provide an even coating. Further details on the operation of a conventional HVLP spray gun can be found in United States Patent Nos. RE36378 issued to Binks Manufacturing Company on Nov. 9, 1999 and U.S. Pat. No. 6,585,173 issued to Sata-Farbspritztechnik GmbH & Co. on Jul. 1, 2003, the entire disclosures of which are hereby incorporated by reference.

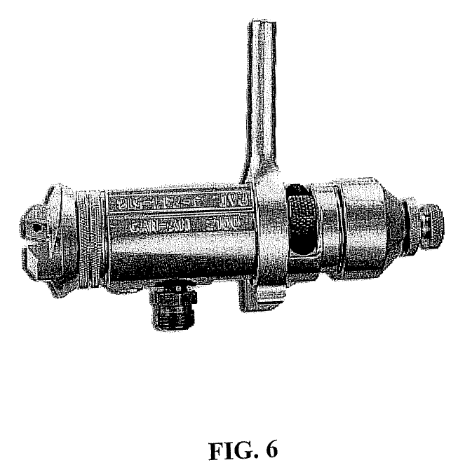

Gun spraying consists of four functions, namely: (1) delivery of the coating to the substrate; (2) atomization the coating; (3) acceleration of the coating to a considerable velocity upon discharge; and (4) guidance of the coating material in the appropriate direction and pattern to cover the substrate. In general, different types of guns can be used to provide these functions. It is desirable to use a “precision” gun with a high transfer efficiency. Different guns can be adapted, as explained below, to provide the desired output—namely a uniform, thin coating of 100 percent solids material. For example, a SATA LP™ jet K3™ HVLP Automatic High Performance Spray Gun, shown in FIG. 5, can be used with one set of parameters. On the other hand, a Can-Am #2100 RC Fluid Recirculation Automatic Spray Gun, shown in FIG. 6 can be used with another set of operating parameters to reach the desired product. Other guns could be used, such as, for example, guns made by DeVilbiss Air Power Equipment or Binks Manufacturing Company. The differences in the Sata and Can-Am guns are illustrated below, however these are merely illustrate examples. It should be appreciated that the guns described herein are provided only as illustrative examples and are not meant to limit the scope of the invention in anyway.

The Sata gun has product specification sheets indicating that it should operate at approximately 50 psi. As discussed below, lower operating pressures assist in the forming of a uniform, thin layer of 100 percent solids coatings. As such, the Sata gun was operated at approximately 30 psi, with a flow rate of approximately 10 cfm. Operating under these conditions produced atomized particles smaller than 25 microns. The large pressure drop upon atomization provides for large amounts of adiabatic cooling. The transfer efficiency when using the Sata gun at 30 psi was between about 50% and about 65% under elevated operating temperatures. Operating at higher pressures, such as about 60 psi, lowers the transfer efficiency to between about 35% and about 50%.

The Can-Am gun operates at about 6 psi to about 8 psi and with a flow rate of approximately 27 cfm. The Can-Am gun produces the low pressure and high flow rates by using a turbine in lieu of a compressor. The turbine acts as a fan and merely amplifies the air flow. The Can-Am gun produces larger particles upon atomization—approximately 25-35 microns on average. Furthermore, the lower operating pressure provides for a smaller pressure drop and therefore a smaller adiabatic cooling effect. The operation of the Can-Am gun under these conditions produced a transfer efficiency of about 70 percent to about 90 percent.

One factor that determines the transfer efficiency regardless of the gun that is used is the spray pattern. The side nozzles or fan nozzles 62 are used to effect the spray pattern. Typically when air is discharged form the coating nozzle 55, the spray pattern is ovular cone. As such, in a single pass, the edges of the spray pattern would be lighter than the center portion. In order to obtain a more uniform spray pattern, it is desirable to develop a flatter spray pattern, ideally to form a nearly rectangular footprint. The air from the side nozzles 62 are directed towards one another and at complimentary angles such that the radial momentum is cancelled and the pattern from the coating nozzle is flattened. The longitudinal momentum of the atomized particles is not altered by the side nozzles, thereby allowing the particles to continue to be dispersed onto the substrate. Thus, the side nozzles changes the direction of the atomized particles of the coating to create the rectangular footprint of distribution.

By operating at a lower pressure, such as with the use of a Can-Am-type gun, the coating particles are subjected to less shear force. Less shear on the coating particles results in overall larger average particle size. Furthermore, high shear can adversely effect the chemistry of the coating.

3. Heat Transfer to the Coating Material and Atomization Air

The application of heat to 100 percent solids material of 100 centipoise results in a decrease of its viscosity to a point where it is more easily atomized. However, the cooling effects of atomization, namely adiabatic cooling, increases the viscosity of the coating material, which adversely effects the flow out and the uniform film build. Adiabatic cooling is caused by the stored energy effects of compressed gas. Adiabatic cooling results from the cooling effect caused by the rapid expansion of a gas as it is released during the atomization process. Conversely, when air is compressed, the compressed air is heated due to the same effect. This is known as adiabatic heating. Conventional atomization techniques utilize compressed air in the range of 30 to 90 psi that is released to deliver the coating to the substrate. Upon the release of the coating, immediate cooling occurs, due to the adiabatic effect. This cooling effect offsets heat input to the coating.

In order to produce the desired optimal results, it was determined that the heat of the atomized spray stream should be between about 80 degrees and about 160 degrees Fahrenheit, and more specifically between about 110 degrees and about 140 degrees Fahrenheit. If the temperature is too hot several adverse conditions can occur. For example, if too much heat is applied there is a possibility that the substrate could be scorched, the chemical composition of the coating could be adversely effected, air could be trapped in the coating thereby creating bubbles, or the substrate could be too absorbent thereby creating dry areas, or areas where the coating soaks into the substrate. Conversely, if the temperature is too cold, there is a possibility that there could be inadequate flow out thereby not covering the substrate or the coating could blotch or stick to create an undesirable “orange-peel” look. Thus, in order to obtain an optimal output temperature, the effect of adiabatic cooling needs to be accurately balanced with the amount of heat added into the spray system. The effect of adiabatic cooling can be evaluated by conducting a heat balance across the coating delivery process. The total heat in the process is the sum of the heat due to adiabatic effects plus the heat contained in the air and the heat contained in the liquid. The adiabatic changes influence both the air and liquid. Further studies were conducted to determine the quantity of air passing through the two systems. As the volume of low-pressure air that is employed to deliver the coating to the substrate becomes larger, a larger heat input to the air was required.

The heat mass balance over the system demonstrates the relative impact of each component. Approximately 1,000 grams of air pass through the atomization gun per minute. When heating the atomizing air from 72 degrees Fahrenheit to 150 degrees Fahrenheit per minute, approximately 85 kJ per gun of heat input is required. Approximately 100 grams of coating pass through the atomization gun per minute. When heating the coating from 72 degrees Fahrenheit to 120 degrees Fahrenheit per minute, approximately 10 kJ per gun of heat input is required. If one assumes that there is approximately 30 cubic feet of air in the immediate vicinity of substrate to be coated, and that the ambient temperature is 110 degrees Fahrenheit, then the heat input required to maintain this temperature would be approximately 11 kJ. It would appear, therefore, that the heat of the atmosphere between the point of atomization and the substrate would have an approximate 10% influence in the total heat to the process. However, when taking into account the rate of airflow from the point of dispensation to the substrate, this influence is almost completely offset by the displacement of ambient air with atomization air. FIG. 6 graphically demonstrates how atomization air displaces ambient air.

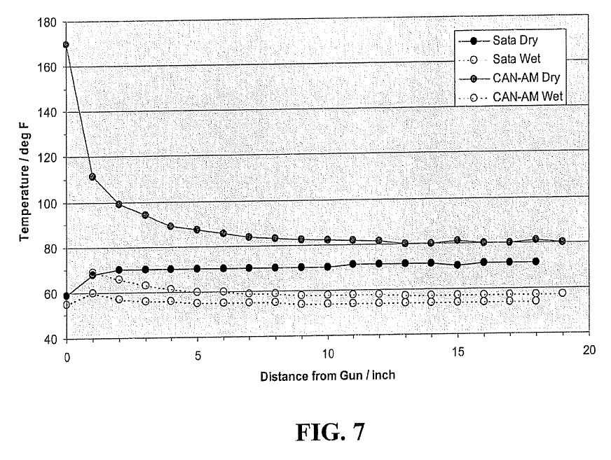

FIG. 7 demonstrates the effects of both adiabatic heating and cooling. Testing was conducted with a Can-Am gun and turbine compressor and with Sata traditional HVLP guns. FIG. 5 is a graphical representation of air stream temperature from a Can-Am system at 8.75 psi and a Sata gun at 40 psi. Also presented are graphs with both guns spraying water at 56 degrees Fahrenheit with a room temperature of 72 degrees Fahrenheit. With the Sata guns, dispensed air and water were cooled well below ambient temperatures and slowly approached ambient temperature over time and distance traveled. With the Can-Am system, the adiabatic heating of the gas/liquid mixture is clearly observed. As it can be seen, the Can-Am system requires less heat to offset the effects of adiabatic cooling.

In order to provide the desired atomization stream using a Sata-type gun, heat is added to the system to offset the effects of adiabatic cooling. The atomization stream is measured at the point of dispensation. Shop air is provided to the gun and is heated until the atomization stream reaches the desired temperature, such as, for example 140 degrees Fahrenheit. In addition, the coating is heated typically to between about 80 degrees Fahrenheit and about 160 degrees Fahrenheit, and more preferably to between 110 degrees Fahrenheit and about 140 degrees Fahrenheit. While this method produces the desired heat of the atomization stream, the stream is still less than ideal as the particles are still rather small and the pressure is still fairly high. Additionally, a greater amount of heat is needed to be added to the air stream to offset the relatively large amount of adiabatic cooling.

In order to provide the desired atomization stream using a Can-Am-type gun, heat is added to the system to offset the effects of adiabatic cooling. However, since the operating pressure is much lower than used in a Sata-type gun, less heat needs to be added to the system. The coating is still heated to between about 80 degrees Fahrenheit and about 160 degrees Fahrenheit, and more preferably to between 110 degrees Fahrenheit and about 140 degrees Fahrenheit. The air stream temperature is set so that the atomization stream is at the desired temperature, such as, for example 140 degrees Fahrenheit. The heat can be added through a heater, or can be taken from the heat generated by the turbine. The turbine typically produces air at approximately 250 degrees Fahrenheit. In a turbine system, the heat of the atomization stream is adjusted by adjusting the air stream temperature, such as by adding insulation and fixing the length between the turbine and the gun chamber. Control measures can be used in order to maintain the temperature of the input components at a point where the atomization stream is at the desired temperature. There was improved “knitting” and flow out and corner coverage, which was also considerably improved when compared to conventional atomization technology for the application of 100 percent solids coatings. The Can-Am-type system also produced a desirable transfer efficiency, about 70-90 percent, a desirable particle size distribution and a less heat input requirement due to the smaller pressure differential.

4. The Coating Applied

The radiation curable, sprayable compositions that are best used in conjunction with the present invention comprise a mixture of: (a) an acrylated epoxy, and (b) at least one multi-functional acrylate and, in certain embodiments, (c) a photoinitiator. These radiation curable compositions comprise a material containing an amino group. In certain embodiments, the compositions are also substantially free of monofunctional acrylate monomers and/or inert solvents. While a description of such compositions follows below, it should be appreciated that the process and final product obtained by the process described herein should not be limited to these illustrative compositions. It should be understood that such illustrative compositions are meant to assist in the comprehension of the process of providing a uniform coating of 100 percent solids material and the finished product resulting from such process.

As used herein, the term “radiation curable” refers to materials having reactive components that are polymerizable by exposure to an energy source, such as an electron beam (EB), UV light, or visible light. In certain embodiments, the compositions used are polymerizable by exposure to UV light. As used herein, the term “sprayable” refers to compositions that are capable of being applied uniformly by atomization through a device such as a spray gun. Sprayability, as will be appreciated by those skilled in the art, is a function of the viscosity of a material. In certain embodiments, the compositions of the present invention have a viscosity of from 2 to 300 centipoise or, in other embodiments, from 20 to 150 centipoise, or, in yet other embodiments, 20 to 100 centipoise, at high shear at 25 degrees Celsius. The viscosities reported herein may be determined using a Cone and Plate viscometer at 5000 cycles per second as understood by those skilled in the art.

The compositions used in connection with the present invention generally comprise an acrylated epoxy. As will be appreciated by those skilled in the art, epoxy acrylates are produced through reaction of epoxy resins with (meth)acrylic acids. As used herein, “(meth)acrylic” and terms derived therefrom are intended to include both acrylic and methacrylic. Moreover, in certain embodiments, the acrylated epoxy comprises an oligomer having a viscosity at 25 degrees Celsius of less than 10,000 centipoises, or, in some cases, less than 5,000 centipoises, or, in other cases, about 1,000 centipoises. In certain embodiments, the acrylated epoxy comprises an oligomer having a Tg (glass transition temperature) of less than 50 degrees Celsius, or, in some cases, less than 25 degrees Celsius or, in still other cases, less than 0 degrees Celsius, or, in yet other cases, less than minus 10 degrees Celsius.

Suitable acrylated epoxies that may be used in these compositions include, without limitation, those which are the reaction product of compounds having at least one epoxide group with compounds having per molecule at least one alpha, beta ethylenically unsaturated double bond and at least one group which is reactive toward epoxide groups. In certain embodiments, the acrylated epoxy may comprise a multi-functional acrylated epoxy. As used herein, the term “multi-functional acrylated epoxy”refers to acrylated epoxies having an acrylate functionality of greater than 1.0.

Some specific examples of acrylated epoxies that are suitable for use in the compositions of the present invention include, without limitation, EBECRYL 3200, 3201, 3211 and 3212, commercially available from UCB Chemicals Corporation, Smyrna, Ga.; PHOTOMER 4025, commercially available from Cognis Corp., Cincinnati, Ohio; LAROMER 8765, commercially available from BASF Corp., Charlotte, N.C.; and CN115, commercially available from Sartomer Corp., Exton, Pa.

In certain embodiments, the composition comprises at least 10 percent by weight of the acrylated epoxy or, in some embodiments, at least 15 percent by weight of the acrylated epoxy or, in yet other cases, 20 percent by weight up to 80 percent by weight, or, in still other embodiments, from 35 up to 65 percent by weight of the acrylated epoxy based on the total weight of the radiation curable composition. In certain embodiments, the composition comprises 10 up to 30 percent by weight of the acrylated epoxy based on the total weight of the radiation curable composition. The amount of acrylated epoxy present in the radiation curable compositions can range between any combination of these values inclusive of the recited values.

The compositions used in connection with present invention generally comprise at least one multi-functional acrylate. As used herein, the term “multi-functional acrylate” refers to monomers or oligomers having an acrylate functionality of greater than 1.0, such as at least 2.0. Multi-functional acrylates suitable for use in these compositions include, for example, those that have a relative molar mass of from 170 to 5000 grams per mole, such as 170 to 1500 grams per mole. In some of these compositions, the multi-functional acrylate may act as a reactive diluent that is radiation curable. Upon exposure to radiation, a radical induced polymerization of the multi-functional acrylate with monomer or oligomer is induced, thereby incorporating the reactive diluent into the coating matrix.

Multi-functional acrylates suitable for use in the radiation curable compositions include, without limitation, difunctional, trifunctional, tetrafunctional, pentafunctional, hexafunctional (meth)acrylates and mixtures thereof. As used herein, “(meth)acrylate” and terms derived therefrom are intended to include both acrylates and methacrylates.

Representative examples of suitable multi-functional acrylates include, without limitation, ethylene glycol di(meth)acrylate, 1,3-butylene glycol di(meth)acrylate, 1,4-butanediol diacrylate, 2,3-dimethylpropane 1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethylenglycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate and mixtures thereof.

In certain embodiments, the radiation curable composition comprises less than 90 percent by weight of the multi-functional acrylate or, in some embodiments, less than 85 percent by weight or, in yet other embodiments, more than 20 percent by weight up to less than 80 percent by weight, or, in still other embodiments, from 35 up to 65 percent by weight of the multifunctional acrylate based on the total weight of the radiation curable composition. The amount of multifunctional acrylate present in the radiation curable compositions can range between any combination of these values inclusive of the recited values.

In certain embodiments, particularly when the radiation curable composition is to be cured by UV radiation, the compositions may also comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present invention. Cleavage-type photoinitiators include acetophenones, alpha-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof.

Specific non-limiting examples of photoinitiators that may be used in the radiation curable compositions include benzil, benzoin, benzoin methyl ether, benzoin isobutyl ether benzophenol, acetophenone, benzophenone, 4,4′-dichlorobenzophenone, 4,4′-bis(N,N′-dimethylamino) benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyldiphenylphosphine oxide, bis (2,4,6-trimethylbenzoyl) phenyl phophine oxide, 2,6-dichlorobenzoyl-diphenylphosphine oxide, and 2,6-dimethoxybenzoyldiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis (2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the radiation curable composition comprises 0.01 up to 15 percent by weight of the photoinitiator or, in some embodiments, 0.01 up to 10 percent by weight, or, in yet other embodiments, 0.01 up to 5 percent by weight of the photoinitator based on the total weight of the radiation curable composition. The amount of the photoinitator present in the radiation curable compositions can range between any combination of these values inclusive of the recited values.

The radiation curable compositions may comprise a material containing an amino group. In some of the compositions, the amino group may be present as part of the acrylated epoxy, as part of the at least one multi-functional acrylate, or the amino group may be present in a separate component of the radiation curable composition. The presence of a material comprising at least one amino group in these compositions is thought to affect, for example, the reactivity of the composition, thereby improving the cure response of the composition.

In certain embodiments, the radiation curable compositions may comprise an amine modified (meth)acrylate. Amine modified (meth)acrylates include, without limitation, amine modified polyether acrylates, amine modified polyester acrylates, amine modified epoxy acrylates, and amine modified urethane acrylates, including mixtures thereof.

Representative specific examples of amine modified (meth)acrylates suitable for use in the compositions of the present invention include, without limitation, the LAROMER line of amine-modified acrylates commercially available from BASF Corporation, Charlotte, North Carolina, such as LAROMER PO77F, PO94F, and LR8996; CN501, CN502, CN550, and CN551 available from Sartomer Corp., Exton, Pa.; and ACTILANE 525, 584, and 587 available from Akcros Chemicals, New Brunswick, N.J. In certain embodiments, the radiation curable composition comprises at least 5 percent by weight, or, in some cases, at least 10 percent by weight, or, in yet other cases, at least 20 percent by weight of a material containing an amino group based on the total weight of the radiation curable composition. In some embodiments, the radiation curable composition comprises 5 up to 50 percent by weight or, in other cases, 10 up to 30 percent by weight of a material containing an amino group based on the total weight of the radiation curable composition. The amount of the material containing an amino group present in the radiation curable compositions can range between any combination of these values inclusive of the recited values.

In certain embodiments, the composition used in conjunction with the present invention is substantially free of monofunctional acrylate monomers and/or inert solvents, such as water and inert organic solvents. Indeed, it has been surprisingly found that the particular compositions are sprayable, while maintaining desired performance properties, such as resistance to mar, toughness, and intercoat adhesion, even if little or no monofunctional acrylate monomers and/or inert solvents are added. Those skilled in the art will appreciate that such materials are known to be low viscosity materials highly desireable for achieving viscosities suitable for sprayability. As used herein, “substantially free” means that the material is not intentionally added to the composition, but may be present at minor or inconsequential levels, because it was carried over as an impurity as part of an intended composition component. In certain embodiments, the amount of monofunctional acrylate monomers and/or inert solvent present in the composition is less than 10 percent by weight or, in some cases, less than 5 percent by weight, and, in yet other embodiments, less than 2 percent by weight based on total weight of the composition. In some embodiments, for example, the compositions of the present invention comprise no monofunctional acrylate monomers.

At least partly due to the absence of significant amounts monofunctional acrylate monomers and/or inert solvents, it is believed, certain compositions exhibit reduced volatility as compared to their radiation curable, sprayable counterparts that include such materials. It is believed that monofunctional acrylate monomers not only react into and become part of the coating during cure, but they also evaporate during cure to a greater extent than multi-functional acrylates. Low volatility results in reduced odor, safer handling, and recyclability.

Moreover, in certain embodiments, the radiation curable compositions may be recyclable. As used herein, a “recyclable”composition is a composition that remains homogenous after spraying and can be re-sprayed after recirculation while maintaining performance properties, such as resistance to mar, toughness, and intercoat adhesion. For example, in certain embodiments, the radiation curable composition may exhibit a weight loss as measured by thermogravimetric analysis (TGA) of less than 10 percent or, in some cases, less than 7 percent or, in yet other cases, less than 2 percent, at 120 degrees Fahrenheit for 12 hours. The TGA weight losses reported herein were determined in a manner that would be understood by those skilled in the art and are intended to simulate spray and recirculation temperatures for certain spray application conditions.

Moreover, certain embodiments of the composition used in conjunction with the present invention exhibit a weight loss of less than 4 percent or, in some cases, less than 2 percent, or in yet other cases, less than 1 percent, as measured by ASTM D5403 Method A, which is specified to simulate potential weight loss of a UV curable coating during UV cure and subsequent finished product aging.

In certain embodiments, the radiation curable composition may comprise a rheology modifier. A number of rheology modifiers, either alone or in combination, may be used to produce compositions according to the present invention. For example, suitable rheology modifiers include, without limitation, fumed silicas, organo-clays, modified ureas, nano-aluminum oxide, non-associate thickeners, and mixtures thereof, among others. A suitable rheology modifier that is commercially available and that may be used in some of the radiation curable compositions is a modified lower molecular weight polymeric urea available from BYK-Chemie USA, Wallingford, Conn. sold under the name BYK-410. In certain embodiments, the rheology modifier promotes the recyclability of the radiation curable compositions.

In certain embodiments, the radiation curable composition may comprise 0.01 up to 5 percent by weight of a rheology modifier, in some embodiments, 0.1 up to 2 percent by weight, or, in yet other embodiments, 0.1 up to 1 percent by weight of the rheology modifier. The amount of the rheology modifier present in the radiation curable compositions can range between any combination of these values inclusive of the recited values.

In certain embodiments, the radiation curable composition used in connection with the present invention may comprise one or more suitable surfactants to reduce surface tension. Surfactants include materials otherwise known as wetting agents, anti-foaming agents, emulsifiers, dispersing agents, leveling agents etc. Surfactants can be anionic, cationic and nonionic, and many surfactants of each type are available commercially. Some embodiments include at least a wetting agent. Still other radiation curable compositions may have additional surfactants to perform additional effects. Some specific wetting agents include siloxane-based, Silwet® L-77 wetting agent, available from OSI Specialties, Inc., the BYK®-306 wetting/leveling agent available from BYK Chemie, and the Dow Corning #57 flow control agent available from Dow Corning, among others.

Other suitable surfactants may also be selected. The amount and number of surfactants added to the radiation curable compositions will depend on the particular surfactant(s) selected, but should be limited to the minimum amount of surfactant that is necessary to achieve wetting of the substrate while not compromising the performance of the dried coating. In certain embodiments, the radiation curable composition comprises 0.01 up to 10 percent by weight of surfactant, in some embodiments, 0.05 up to 5 percent by weight, or, in yet other embodiments, 0.1 up to 3 percent by weight of surfactant. The amount of surfactant present in the radiation curable compositions can range between any combination of these values inclusive of the recited values.

In certain embodiments, the radiation curable composition used in connection with the present invention comprise a UV-light stabilizer, such as, for example, a suitable hindered-amine or a UV absorber, such as substituted benzotriazole or triazine. Any of a number of such materials may be used to produce a suitable radiation curable composition. For example, suitable UV-light stabilizers include a hindered-amine sold under the name TINUVIN 292 and UV absorbers sold under the names TINUVIN 328 and TINUVIN 400, all of which are available from Ciba Specialty Chemicals.

In certain embodiments, the radiation curable composition comprises 0.01 up to 10 percent by weight of the UV-light stabilizer and/or UV absorber, in some embodiments, 0.01 up to 5 percent by weight, or, in yet other embodiments, 0.01 up to 2.5 percent by weight of the UV-light stabilizer and/or UV absorber. The amount of the UV-light stabilizer and/or UV absorber present in the radiation curable compositions can range between any combination of these values inclusive of the recited values.

Some radiation curable compositions may also include other additives. For example, the radiation curable compositions may contain dyes, pigments, sanding additives, antioxidants, flatting agents (e.g. wax-coated or non-wax coated silica or other inorganic materials), among other materials.

Since the coating material is 100 percent solids, the overspray can be recovered and reused to increase transfer efficiency. In this regard, the rheology of the coating material is not substantially changed between applications. However, it is preferred to provide a process that minimizes overspray and thus does not require recycling, which generally includes recovery and reuse, of the coating material in order to achieve the desired transfer efficiency.

5. Coating Particle Velocity and Size

In order to achieve a high transfer efficiency it is desirable to provide an atomization stream in which the particles have a high momentum. Particle momentum is comprised of particle size and particle velocity. The higher the momentum of the particles, the better chance the particles will reach and stick to the substrate. For example, the higher velocity will assist in avoiding drift, while larger particles avoid deflection.

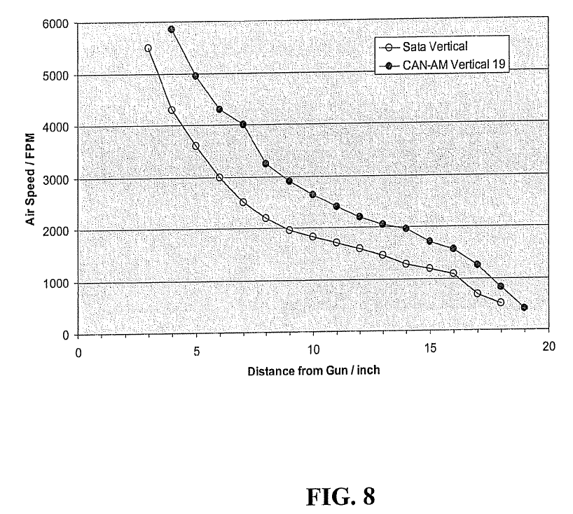

FIG. 8 illustrates the speed of the coating particles versus distance from the gun. It should be noted that the process described herein is ideally designed for gun to substrate distances ranging between 4 inches and 36 inches, although adjustments can be made to the process to accommodate other distances. It can be seen from FIG. 8 that the Can-Am system produces a higher flow rate than the Sata system, which is consistent with the relative air speed temperatures. The higher particle velocity assists in the Can Am system providing superior transfer efficiencies and a better coating of recessed areas. This is because a greater percentage of atomized particles of coating traveled at a greater speed and thus adhered to the surface of the substrate.

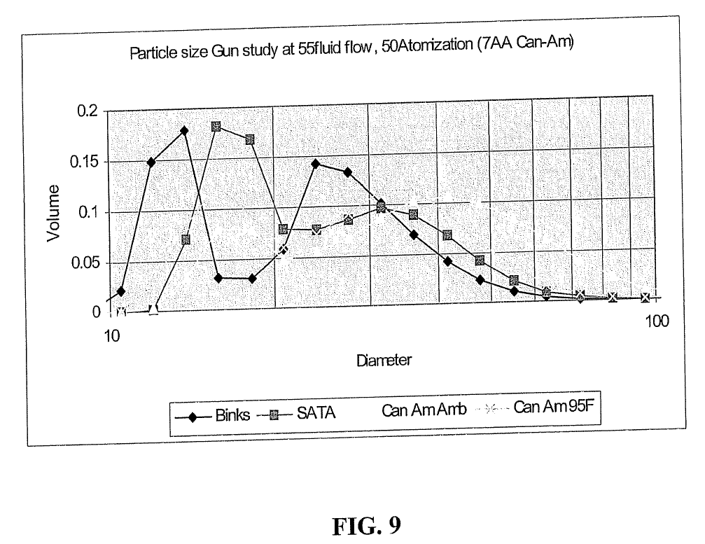

FIG. 9 illustrates an analysis of coating particle size distribution created upon atomization using several HVLP guns. Specifically, a Binks and a Sata gun were used as conventional HVLP guns and compared to a Can-Am gun operating at two different temperatures. As can be seen in FIG. 9, the Can-Am guns produced particles with a larger average diameter. While the Can-Am gun operating at ambient temperatures produced the highest average particle size, it did not have as good of results in transfer efficiency or flow out when compared to the Can-Am gun operating at elevated temperatures. This can be attributed to the other factors mentioned below.

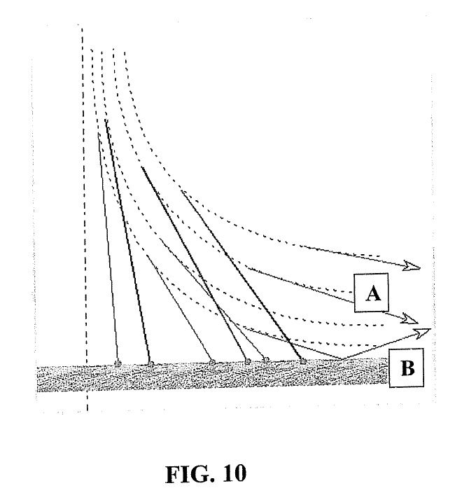

The data produced in FIG. 9 in combination with the actual test results support the finding that larger particle size (>25 microns) is desirable, but that warmer coating is necessary for acceptable appearance and superior transfer efficiency. The larger particle size improves corner coverage and provides the increased momentum to assist in assisting in getting the particles to the substrate and having them stick upon impact. The smaller particles (<25 microns) can be carried away by the blowback of atomization air hitting the part, while the larger particles have the mass to hit the part. The largest particle size average was found with the Can-Am system using ambient temperature air. In this instance the largest particles did not produce the best transfer efficiency or acceptable appearance. This is due to the coating rheology and the ability of particles to adhere to the substrate or to “bounce” off of the substrate. When the atomizing air is warm, the viscosity of the coating is lowered as is the initial contact angle with the substrate, and the coating adheres to the substrate. FIG. 10 illustrates the trajectory of the atomized particles as they leave the gun nozzle and head towards the substrate. Smaller particles can be swept away, as shown as A, while cool particles can deflect off the substrate surface, as shown as B. Particle sweep and particle deflection hinders good transfer efficiency and may result in uneven coverage.

Based on these findings, it is generally desirable to provide a heated stream with a relatively high momentum. It is preferred to provide an atomization stream with a particle distribution primarily between about 25 microns and about 50 microns, and preferably between about 25 microns and 35 microns. In addition, it is preferable to provide an atomization stream at about 25 cfm per gun.

6. System Controls

Spray gun arrangements for wood substrate coatings use many forms of flow-restrictors to achieve reduced flow of coating during spray. The fluid is supplied from a reservoir, and typically pressurized from 10 to 100 psig, and then restricted in flow near the gun by a diaphragm valve or a needle valve, and then by the fluid nozzle orifice. Pressure drop techniques, such as these, do not regulate coating fluid flow well, because changes in viscosity due to fluid variation, temperature or thixotropy will cause a significant build variation on the substrate during the spray process. Similarly, when a coating fluid mixture encounters variations in mix, due to settling, foreign material, or supply-pressure variation, a significant change in flow rate can occur in fractions of a second.

To avoid the variation in coating delivery, a flow control system can be employed. Flow control with a feedback loop eliminates flow-rate variations due to coating fluid supply variations, thermal changes, and delivery equipment creep. A flow controller that is regulated by pressure, so that flow at the gun input is constant, results in a constant build for the fan pattern. Flow control is achieved with a constant displacement meter or a Coriolis meter, or other flow measuring devices, where the flow-measurement is compared to a desired flow, and the regulator is adjusted, accordingly, to keep the flow rate constant. Measurements can be taken on a regular sampling basis and the meter can be adjusted accordingly. In order to maintain a precise coating flow rate, a fast sampling time period can be used.

Thermocouples can be placed in a number of locations about the system and tied to a control system. For example, one or more thermocouples can be placed proximate to the discharge nozzle and used to regulate the temperature of the atomization stream. Samples can be taken in regular intervals and the temperature of the air input stream can be adjusted accordingly.

7. The Substrate

The substrate of this process can be any material, however wooden substrates are preferred. Furthermore, while most tests were performed on wooden cabinet pieces, the process described herein can be applied to a number of different product with different shapes and sizes. In addition, three-dimensional substrates can be coated with 100 percent solids materials using the process described herein. Three-dimensional substrates include any type of substrate and may generally include items that have edges, grooves, corners or other areas that are typically difficult to coat.

In general, to achieve a uniform coating there must be flow out of the material across the surface of the substrate. Flow out refers to “wetting” or the ability of the liquid to spread out evenly over the surface of the substrate. For example, water has a relatively low viscosity but water will not flow out evenly over the surface of a freshly waxed surface, because the surface tension of water is higher than the surface energy of the waxed surface. The molecules must have a stronger attraction to the molecules of the substrate surface than to each other in order for wetting to occur. Therefore this interaction is a function of both the rheology of the coating (also temperature and surface tension) and the surface characteristics of the substrate.

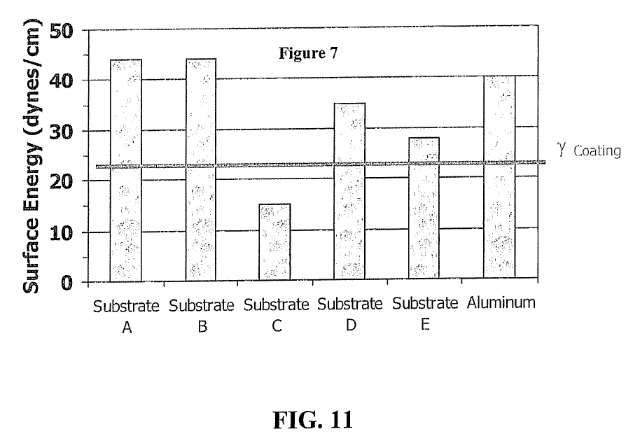

FIG. 11 illustrates an examination of the surface energy of several substrates. In cases where the energy in the formulations was lower than the surface energy in substrates, there was wetting and flow out. As such, Substrates A, B, D, E, which were wooded substrates, and the Aluminum Substrate all formed a uniform coating when the process of the present invention was used to coat the substrates. Substrate C, which had a very low surface energy which was similar to Teflon, did not provide adequate flow out and therefore did not have a uniform coating applied. In order to raise the surface energy on substrates that would not have a surface energy higher than that of the formulation, the composition of the coating can be altered, include low surface energy surfactants in the composition, or heat can be applied to the surface of the substrate. The surface energy of the substrate can be increased by pre-treating the surface, for example by corona treatment, by sanding, or by adding chemicals with compatible chemistries.

8. Heat Applied to the Substrate

Heat is typically applied to the substrate to provide improved flow or wetting of the surface area. By heating the substrate, the coating is heated or maintains heat and reduced viscosity and the contact angle of the liquid on the substrate is reduced. As a result, the coatingflows across the surface, thereby providing an even coating. The elevated temperatures will also lower the viscosity of the coating material, thereby providing improved flow out across the surface of the substrate.

When heat is applied to the substrate, it should be applied in a controlled and measured manner to ensure that the substrate is not adversely effected. For example, wood is a porous material and as such, extreme heating will cause material degradation, including drying, splitting, and combustion. Extreme heating would also provide for uneven flow out, leaving areas of the substrate dry or uncoated. High heating will also cause the wood will off gas which will result in holes in the finished surface. If the substrate is too cool, the contact angle of the coating hitting the surface is too high and the coating will have reduced flow, which will result in a change in rheology and an unacceptable appearance. Flow out will not occur resulting in a rough, uneven or “orange peel” appearance. In the case of non-wood or non-porous substrates, the rough, uneven appearance would still be a concern for cooler substrate temperatures.

It is preferable to heat the substrate to between about 80 degrees and about 160 degrees Fahrenheit, and more preferably to between about 100 degrees and about 120 degrees Fahrenheit. Any method of heating the substrate would be acceptable, although it is preferred to use infrared heaters due to the quick transfer of energy. In some embodiments the substrate, as well as the chamber air, can be heated by the air from the UV oven. This provides a “free”source of heat for the substrate and allows for only one source of air to be treated.

9. Applicators

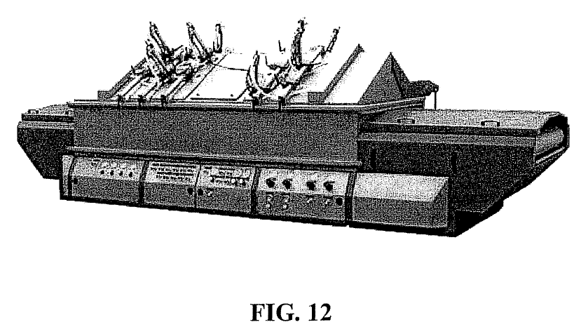

Many different types of applicators can be used to implement the process and produce the product as described herein. Examples of such applicators as those made by Dubois Equipment Co., Inc., Superfici Inc., and Cefla Group. The general components of the applicator is set forth above and FIG. 12 is a photograph of a Dubois Mist Coater. It should be noted that a variety of applicators can be used. For example the applicator can be (1) a hand held spray which is applied to a fixed substrate; (2) a horizontal fixed spray head with the substrate on a conveying system; (3) a horizontal reciprocating spray head with the substrate on a conveying system; (4) a vertical, or hanging, reciprocating spray head with the substrate on a conveying system; (5) a vertical, or hanging, articulating spray head with the substrate on a conveying system; or (6) any other mechanism in which the sprayers can encounter the substrate in a uniform manner. Furthermore, it should be noted that any one of these applicators can be used in connection with a recirculation system to ensure high levels of transfer efficiency. However, it is preferred to maximize the transfer efficiency on the first pass, as recirculated coating particles will be subject to increased stress and shear which may adversely effect the look of the finished product.

10. Chamber Control

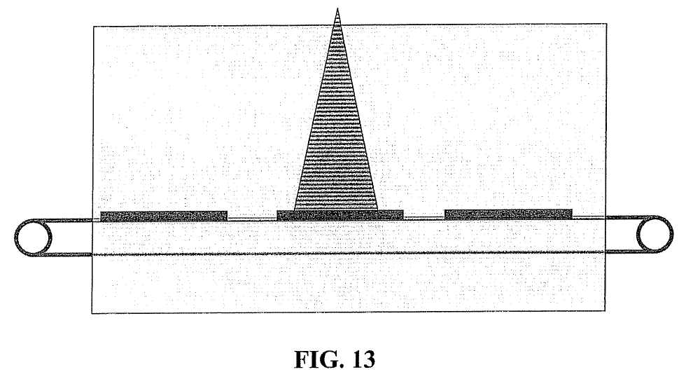

As mentioned above, the chamber temperature control is not nearly as critical as the control of other temperatures. This is because there is not as much heat lost to the surrounding air, and more importantly, due to the positive displacement of the air by the atomized stream. The displacement of air is illustrated in FIG. 13. It is preferred to use heated air within the spray chamber, preferably between about 80 degrees and about 160 degrees Fahrenheit, and more preferably between about 110 and about 130 degrees Fahrenheit. The heat for the chamber air may come from other portions of the spraying system, such as, for example, from the UV oven. Such use of the air not only saves in the amount of input heat, but also generates less waste streams.

B. The Process

The process embodiments described below are meant to be illustrative examples of processes that can be used to achieve uniform thin film coatings on three-dimensional substrates. These embodiments are not meant to be limiting, as the parameters for the different process variables are provided for in the above-sections.

1. First Embodiment of the Process

In a first embodiment, a wooden substrate is sprayed with a uniform thickness of coating, and cured by UV energy. The coating build in this embodiment is a one hundred percent solids sealer of 0.0004 inches thick, and a one hundred percent solids topcoat of 0.0006 inches film thickness. Thus, the total 100 percent solids build is 1 mil thick.

In this embodiment, the substrate receives this constant thickness of coating from a Mist Coater machine that uses four delivery guns for the sealer coat in the first booth, and four guns for the topcoat in the second booth. The guns are arranged the same in each booth: 1) one side gun at 45-degrees from horizontal (spray direction), about 10 to 14 inches from the centerline of the conveyor belt; 2) one or two center guns centered on the belt, 90-degrees from horizontal, and 19-inches from the belt; and 3) a second side gun on the opposite side, but as a mirror image of the first side gun.

The guns are arranged so that there is about 2-feet between each fan footprint.

The atomization pressure is 40 psig. The guns are SATA™ HVLP guns with 0.7 mm nozzles and matching air-caps. The fan pressure is 40 psig for all guns. Air is supplied to the booths to heat the booth cavity, and to keep the guns, inside the booth lid area, at 110 degrees Fahrenheit.

The substrate is heated to 110 degrees Fahrenheit by infrared heat, and then enters the sealer booth on a conveyor belt, or like transfer means. Coating is then applied. Sealer side guns each deliver about 0.5 oz/min with atomization air on, while sealer center guns each deliver about 3.2 oz/min with atomization air on. The sealer coat is partially cured by UV energy, allowing some surface free radicals for adhesion to the topcoat. The substrate is then sealer sanded. The substrate then enters the topcoat booth at 110 degrees Fahrenheit, and the four topcoat guns deliver topcoat fluid uniformly to the substrate. Topcoat side guns each deliver about 1.0 oz/min with atomization air on, while topcoat center guns each deliver about 4.8 oz/min with atomization air on. The substrate exits the topcoat booth and enters the UV lamp chamber for final cure.

The belt travels at approximately 20-85 feet per minute throughout the entire process. While the pre-heater, flash-chamber and spray booths are about 6-15-feet long each, the UV cure oven is about 20-50-feet long.

The fluid delivery system is regulated by an ITW DR-1™ diaphragm regulator. The regulator is piloted by an air pressure source that is controlled by an Allen Bradley SLK500™ programmable logic controller (PLC). The regulator reads the fluid flow rate from meshed tooth constant-displacement meters that are positioned immediately upstream of each gun. The PLC monitors each gun individually, with no crosstalk information between flow meters.

To coat the back, the substrate is turned over and run through the process again. For substrates coated on both sides, the preferred operation is back sealer, front sealer, back topcoat, front topcoat, so that the sides are coated with intervals of sealer and topcoat.

This process provides for a simple application, uniformity, and low material costs.

2. Second Embodiment of the Process

A reciprocator, such as a Cefla Easy 2000™, or Superfici Twin Spray, can be used in place of the Mist Coater. The guns and flow equipment would be the same. The reciprocator is significantly different than the Mist Coater, because reciprocators use electric eyes to locate the substrate, and then only coat those areas. Hence the substrate can be sprayed with a thin and uniform coating using a 100 percent solids coating, a solvent coating, or a waterborne coating.

3. Third Embodiment of the Process

The process is as described above with the following modifications. The temperature is controlled above ambient through five mechanisms. The coating is heated at the source-tank area, the coating is reheated at the gun area, the atomization air is heated, the booth air is heated, and the substrate is preheated before coating. The gun setup can be of a Can-Am type where the pressure drop across the point of atomization is reduced. This lowers the effects of adiabatic cooling, requiring less heat input. This type of setup also results in larger average atomized particle size with a larger average particle velocity. The substrate may also be subjected to additional heat during a dwell period after coating. For the PPG coating 1593 sealer, the following temperature ranges are recommended for best flow-out and uniform-build of coating:
Tank Heater: 100-180 degrees Fahrenheit
Gun Heater: 100-200 degrees Fahrenheit
Atomization air 60-200 degrees Fahrenheit
Booth temperature: 70-150 degrees Fahrenheit
Substrate Temperature 70-140 degrees Fahrenheit

The coating temperature can be enhanced by the additional heating within the spray gun. This can be achieved by delivering the atomization air at an elevated temperature. It has been measured, as with a turbine-air gun, that the gun has 7 cc of coating flowing within it at all times. At a deliverance of 3 oz/minute, this can result in a gun heating time of 6-7 seconds within the gun. Since nearly ten-times as much mass of air than coating is used in the gun, the air acts as a near-infinite source of heat at elevated temperature.

To get good coating distribution, especially in uneven areas, such as, for example, inside corners, the conveyor speed in the spray booth can be controlled. At 30 feet per minute, for a target build, the flow to the corners of panels is sufficient. By increasing the conveyor belt speed to 35 feet per minute, the flow to the panel edges and corners is not as likely. With the addition of temperature enhancement, the surface tension of the coating is reduced and the corresponding contact angles, flow and edge-of-panel coverage is improved. At lower temperatures of application, the effect of surface tension of the coating versus the substrate (higher versus lower) is significant, and flow to the panel edges and corners is significantly reduced, resulting in undesirable “starved” areas.

Additional sources of heat for the process can also be envisioned. For example, the gun hoses can be heated, the fan air can be heated, and the like. All of these processes have to be balanced with the degradation that extra heat can cause to the coating and substrate. All temperatures can be set and monitored to maintain the optimal operating temperatures. Closed-loop monitoring systems can be coupled to a set of thermocouples with a set sampling period. The monitoring system can adjust the system temperatures to maintain the desired operating temperatures.

C. The Finished Product

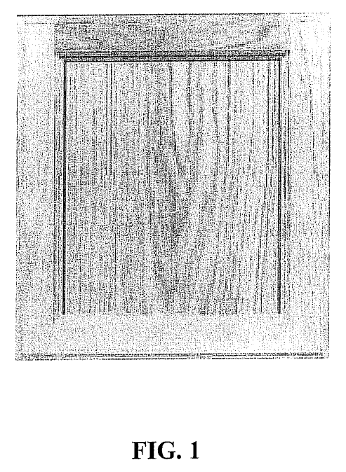

The finished product is a thinly coated substrate with a uniform finish. FIG. 1 illustrates an example of such a product, a cabinet component. The finished product has a uniform sub-one mil coating formed from 100 percent solids coating material. Using the process as described herein, a finished product with a uniform build is established with a 100 percent solids coating and with transfer efficiencies rivaling that of electrostatic bell procedures, which is approximately 20 percent better than conventional gun systems. While this application has generally described the finished product as a wooden component, such as a cabinet component, it should be appreciated by one skilled in the art that the process described herein can be applied to a number of different substrates to produce a thinly coated finished product.

1. A coated product comprising:
a three-dimensional substrate; and
a one hundred percent solids coating applied to said three-dimensional substrate, wherein said coating is applied uniformly on said three-dimensional substrate to form a thin film layer of coating that is 0.001 inches or less thick.

2. The coated product of claim 1, wherein said substrate is wood.

3. The coated product of claim 1, wherein said substrate is a wooden cabinet component.

4. A coated three-dimensional product formed by a process comprising:
supplying a coating material comprised of one hundred percent solids material to a dispensing mechanism; and
applying said coating material from said coating mechanism to the three-dimensional substrate to provide a uniform thin film coating of said coating material on said three-dimensional substrate.

5. The product of claim 4, wherein said uniform thin film coating has a film thickness 0.0015 inches or less.

6. The product of claim 4, wherein said uniform thin film coating has a film thickness 0.001 inches or less.

7. The product of claim 4, wherein said coating material is UV curable.

8. The product of claim 4, wherein said substrate is comprised of wood.

9. The product of claim 4, wherein said substrate is a cabinet component.

10. The product of claim 4, wherein said process further comprises the step of atomizing said coating material to form an atomization stream.

11. The product of claim 10, wherein said atomization stream is temperature controlled.

12. The product of claim 11, wherein said atomization stream is controlled to be between about 80 degrees Fahrenheit and about 160 degrees Fahrenheit.

13. The product of claim 11, wherein said atomization stream is controlled to be between about 110 degrees Fahrenheit and about 140 degrees Fahrenheit.

14. The product of claim 4, wherein the coating material is comprised of particles having an primary particle size in the range of about 25 microns to 50 microns.

15. The product of claim 4, wherein said coating material comprises a sealer and a topcoat.

16. The product of claim 4, wherein said process further comprising the step of sanding or scuffing said substrate.

17. The product of claim 4, wherein the coating material is applied to said substrate by a high precision spray gun.

18. The product of claim 4, wherein said high precision spray gun is a SATA LP™ jet K3™ HVLP Automatic High Performance Spray Gun or a Can-Am #2100 RC Fluid Recirculation Automatic Spray Gun.

19. The product of claim 4, wherein said process further comprises the step of adding heat to said coating material.

20. The product of claim 19, wherein said coating material is heated to between about 80 degrees Fahrenheit and about 160 degrees Fahrenheit.

21. The product of claim 22, wherein said coating material is heated to between about 110 degrees Fahrenheit and about 140 degrees Fahrenheit.

22. The product of claim 4, wherein said process further comprises the step of providing a pressurized air stream.

23. The product of claim 4, wherein said process further comprises the step of heating said pressurized air stream.

24. The product of claim 23, wherein said pressurized air stream is heated to between about 80 degrees Fahrenheit and about 160 degrees Fahrenheit.

25. The product of claim 23, wherein said heat is supplied from an external source.

26. The product of claim 23, wherein the coating material is applied to said substrate by a high precision spray gun and said heat source is a component of said high precision spray gun.

27. The product of claim 4, wherein said process further comprises heating said substrate to between about 80 degrees Fahrenheit and about 160 degrees Fahrenheit prior to application of said coating.

28. A coated product comprising:
a three-dimensional substrate; and
a uniform thin film coating applied to said substrate, wherein said thin coating film comprises a multi-layer composite coating comprised of one hundred percent solids material, and wherein each of the topcoat and the sealer are applied uniformly on said three-dimensional substrate to form said thin film that is approximately 0.001 inches or less thick.

29. The coated product of claim 28 wherein said three-dimensional substrate is a wooden cabinet component.
